(19) United States
(12) Patent Application Publication
(10) Pub. No.: US 2010/0170236 A1
(43) Pub. Date: Jul. 8, 2010

(54) ATMOSPHERIC PRESSURE HYDROPOWER PLANT

(76) Inventor: Shoetim Lezi, Santa Barbara, CA (US)

Correspondence Address: BELASCO, JACOBS & TOWNSLEY LLP;HOWARD HUGHES CENTER, 6701 CENTER DRIVE WEST, 14th Floor, LOS ANGELES, CA, 90045, US

(21) Appl. No.: 12/410,349

(22) Filed: Mar. 24, 2009

Related U.S. Application Data
(60) Provisional application No. 61/142,635, filed on Jan. 6, 2009.

(51) Int. Cl. F03B 13/08; F15B 5/00

(52) U.S. Cl. 60/398; 137/82

(57) ABSTRACT

An apparatus and method for increasing energy harnessed from a liquid body flowing through a conduit includes a conduit having ascending, connecting and descending sections, valves inside the conduit, a fill unit, and at least one turbine. The valves, located in the ascending and descending portions of the conduit, regulate the flow of the liquid body through the conduit. The fill unit includes at least one of a pump and a siphon for replenishing liquid in the conduit and initiating a constant flow. An optional removably attached extension to the conduit increases the hydraulic head and increases the flow of the liquid body. The extension may include additional turbines. The turbines harness energy from the liquid body flowing with an increased flow rate through the conduit. The harnessed energy is increased by utilizing the atmospheric pressure exerted on the liquid body resulting in an increased constant flow through the conduit.

### RELATED APPLICATION

This application claims priority from U.S. Provisional Application No. 61/142,635, filed Jan. 6, 2009, and incorporates by reference the disclosure thereof.

### FIELD OF INVENTION

The invention relates to facilities for use with hydro-electric power plants. More particularly, this invention relates to an atmospheric pressure penstock for a hydro-electric power plant. The novel penstock design provides for increasing harnessed energy derived from a liquid body flowing through a conduit using atmospheric pressure exerted on the surface of the liquid body.

### BACKGROUND OF THE INVENTION

Hydro-electric power plants have been in use for many years and engineers have constantly sought means to make them more efficient. One of the factors effecting efficiency is the height from which water will fall in a given location. This measure of “head” determines the power that can be extracted from the falling water as it passes through a turbine to generate electricity. The present invention makes use of hydrodynamic technology to artificially increase the relative head available for a generating system in any given geographic location.

Various inventions have been developed to improve the efficiency of hydroelectric generating plants. U.S. Pat. No. 4,182,123, issued to Ueda, discloses a hydraulic power plant that has a reservoir with a dam wall, a water turbine connected to a generator, a penstock extending from the reservoir to the water turbine and passing over the dam wall without passing through the dam wall to supply water from the reservoir to the turbine, and a vacuum pump adapted to fill at least a portion of the penstock with water by a siphon effect and being connected at a substantially uppermost portion of the penstock which is located on the top of the dam wall.

U.S. Pat. No. 5,377,485, issued to Bellamy is directed to systems having low head energy, in for example a river flow. These systems are used to provide electrical energy by directing the water through a duct, and by inducing air into the duct to create an air flow that is drawn over an air turbine to excite same, and thereby produce electrical energy. The air can be introduced into the flowing water in the duct by a switching arrangement to ensure that no bubbles or pockets of air travel along with the water, which impairs efficiency. The duct may be in the shape of an anti-gravity course to prevent the bubbles from traveling.

U.S. Pat. No. 4,364,228, issued to Eller illustrates a hydraulic turbine system includes that an electric generator; rotary turbine blades; a hydraulic pump for operation by rotation of the turbine blades; a hydraulic motor for driving the generator; a hydraulic reservoir; and connections between the pump, the motor and the reservoir for causing the motor to operate in response to rotation of the turbine blades by water flow. In the present improvement, the turbine blades and the hydraulic pump are unified in an axial flow unit which has an annular outer casing through which water flows to drive the turbine blades which in turn drive the pump. The motor, the generator and the reservoir may be located remotely from the axial flow unit. The axial flow unit is preferably generally U-shaped so that it can be placed inverted over a dam with the legs extending down into the water on opposite sides of the dam. A priming unit is provided for starting flow of water through the axial flow unit, and the priming unit may preferably include a vacuum pump connected to the casing for pumping air from the casing to draw water up into the legs thereof until water starts flowing by siphon action.

U.S. Pat. No. 6,359,347, issued to Wolf disclose a method and apparatus for generating hydroelectric power from a water source by lifting water from a relatively lower position to a second relatively raised position. The water is moved in a generally upward direction stepwise from a lowermost tier to an uppermost tier in a plurality of stacked tiers. The water from the water source is initially upwardly siphoned to the lowermost tier. The water from the lower tier is then upwardly siphoned to a next adjacent higher tier. The water from the uppermost tier is channeled down to turn a turbine driven generator to produce electrical power.

It is an objective of the present invention to provide an apparatus and method to improve the efficiency of hydroelectric power plants in geographic locations where the relative head available for power generation is limited. It is a further objective to provide systems to improve these power plants that can be installed as part of an initial installation or added as an improvement to existing power plants. It is a still further objective of the invention to provide systems and apparatus that are easy to construct, simple to operate and easy to maintain. It is yet a further objective to provide apparatus that will allow for further increases in efficiency through the addition of auxiliary outlet routing means. It is another objective to provide these auxiliary outlet routing means with additional downstream turbines. Finally, it is an objective of the present invention to provide power systems that are inexpensive and long lasting.

While some of the objectives of the present invention are disclosed in the prior art, none of the inventions found include all of the requirements identified.

### SUMMARY OF THE INVENTION

The present invention addresses all of the deficiencies of prior art interactive training systems for merchandise bag packing and apparatus for same inventions and satisfies all of the objectives described above.

The apparatus and method disclosed herein increase energy harnessed from a liquid body flowing through a conduit. The invention includes the conduit, multiple valves inside the conduit, a fill unit provided on the conduit, an optional removably attached extension, and a turbine. The conduit comprises an ascending section and a descending section connected via a connecting section. The valves inside the conduit regulate flow of the liquid body through the conduit. The fill unit comprises at least one of a pump and a siphon for replenishing the liquid body in the conduit and impelling a constant flow of the liquid body into the conduit. The constant flow is impelled by selectively controlling one or more of the valves and utilizing the atmospheric pressure exerted on the surface of the liquid body. The removably attached extension increases the hydraulic head of the liquid body and consequently increases the constant flow of liquid body through the conduit. The turbine is preferably located on the descending section of the conduit at a level lower than the surface of the liquid body. The turbine harnesses energy from the liquid flowing with the increased constant flow in the conduit. The harnessed energy is increased utilizing the atmospheric pressure exerted on the liquid body and the increased constant flow.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 illustrates an apparatus for increasing harnessed energy from a liquid body flowing through a conduit enclosing one or more turbines; the conduit filled utilizing a pump, siphon and a fill tube and using atmospheric pressure exerted on a surface of the liquid body;

FIG. 2 exemplarily illustrates an apparatus for increasing energy harnessed from a body of water flowing through a conduit utilizing a pump and a fill tube; and

FIG. 3 exemplarily illustrates an apparatus for increasing energy harnessed from a body of water flowing through a conduit utilizing a siphon.

### DETAILED DESCRIPTION OF THE PREFERRED EMBODIMENT

For purposes of illustration, the detailed description refers to production of electricity at an impoundment hydropower plant. The scope of the atmospheric pressure hydropower plant disclosed herein is not limited to an impoundment hydropower plant but may be extended to preexisting or new impoundment, diversion, and pumped storage hydropower plants.

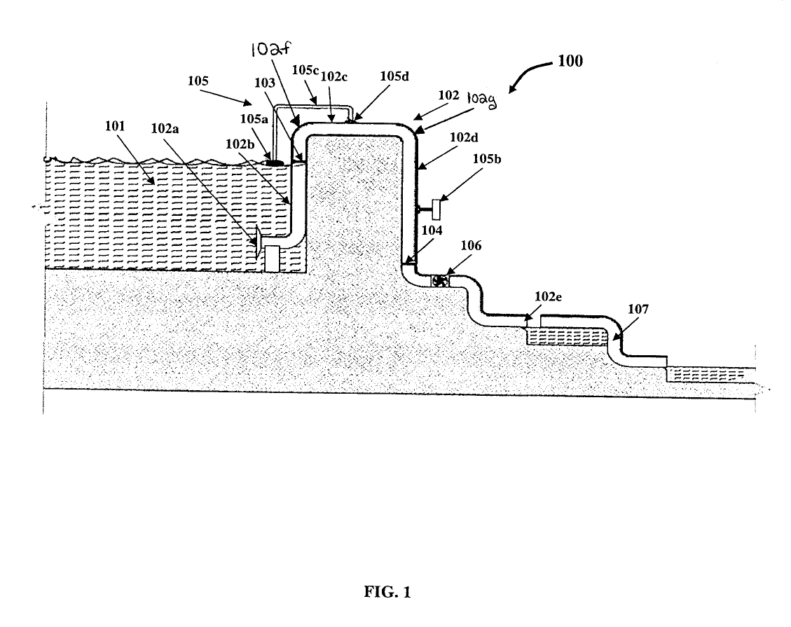

FIG. 1 illustrates an apparatus 100 for increasing harnessed energy from a liquid body 101 flowing through a conduit 102 using atmospheric pressure exerted on a surface of the liquid body 101. The conduit 102 is also referred to as a penstock. The liquid body 101 is typically, a body of water.

The apparatus 100 disclosed herein comprises the conduit 102, multiple valves 103 and 104 inside the conduit 102, a fill unit 105 provided on the conduit 102, a removably 102b and a descending section 102d connected via a connecting section 102c. The conduit 102 is a pipe carrying water to the turbine 106. The valves 103 and 104 comprise an anterior control valve 103 and a posterior control valve 104. The anterior control valve 103 is located inside the ascending section 102b. The posterior control valve 104 is located inside the descending section 102d.

The ascending section 102b extends from an inlet 102a below the surface of the liquid body 101 to the first end 102f of the connecting section 102c at a height above the surface of the liquid body 101. The liquid body 101 enters the conduit 102 through the inlet 102a. The descending section 102d extends from the second end 102g of the connecting section 102c at the height above the surface of the liquid body 101 to a predetermined point below the surface of the liquid body 101.

The valves 103 and 104 inside the conduit 102 regulate flow of the liquid body 101 through the conduit 102. The fill unit 105 comprises at least one of a pump 105a and a siphon 105b for replenishing the liquid body 101 in the conduit 102 and inducing a constant flow of the liquid body 101 into the conduit 102. The constant flow is controlled by selectively modulating one or more of the valves 103 and 104 and utilizing the atmospheric pressure exerted on the surface of the liquid body 101. If the descending section of the conduit is much longer than the ascending section, only one valve 104 is used. The pump 105a may be located in the liquid body 101 near the ascending section 102b of the conduit 102. The pump 105a pumps liquid from the liquid body 101 into the conduit 102. The siphon 105b siphons water from the liquid body 101 into the conduit 102. The siphon 105b is located on the conduit 102 between the anterior control valve 103 and the posterior control valve 104. An access door 105d is provided on the conduit 102 for allowing the pumped or siphoned water to enter the conduit 102. The access door 105d is also used to stop the flow of the water in the conduit 102. To stop the flow of the water in the conduit 102, the access door 105d is opened and air is allowed to enter the conduit 102, thereby stopping the flow. The fill unit 105 further comprises a fill tube 105c for carrying water from the pump 105a to the access door 105d.

The removably attached extension 107 increases the hydraulic head of the liquid body 101 and consequently increases the constant flow of liquid body 101 through the conduit 102. An increase in the hydraulic head corresponds to an increase in the rate of flow of the liquid body 101 through the conduit 102. The removably attached extension 107 that is used depends on the surrounding terrain. The turbine 106 is preferably located on the descending section 102d of the conduit 102 at a level lower than the surface of the liquid body 101. The turbine 106 harnesses energy from the liquid body 101 flowing with the increased constant flow in the conduit 102. The harnessed energy is increased utilizing the atmospheric pressure exerted on the liquid body 101 and the increased constant flow of the liquid body 101 in the conduit 102. The liquid body 101 exits the conduit 102 through an outlet 102e. The liquid body 101 exits the conduit 102, for example, into a lake, a river, a stream, etc. The liquid body 101 does not need to be released into a large second liquid body and can be released even into small streams and lakes. The liquid body 101 is also released into air. Air offers less resistance to the released liquid body 101, hence releasing the liquid body 101 into the air does not resist the constant flow of the liquid body 101 inside the conduit 102. The conduit 102 may, for example, be built on a hill and the liquid body 101 released into the air from the top of the hill, thereby increasing the hydraulic head of the liquid body 101. The liquid body 101 may be released into the air at a large distance from the inlet 102a. Additional turbines 106 may be located at any point in the conduit 102 or in the removably attached extension 107. These additional turbines 106 will serve to slow the flow of the liquid body 101, thereby decreasing erosion problems without reducing the amount of electricity produced.

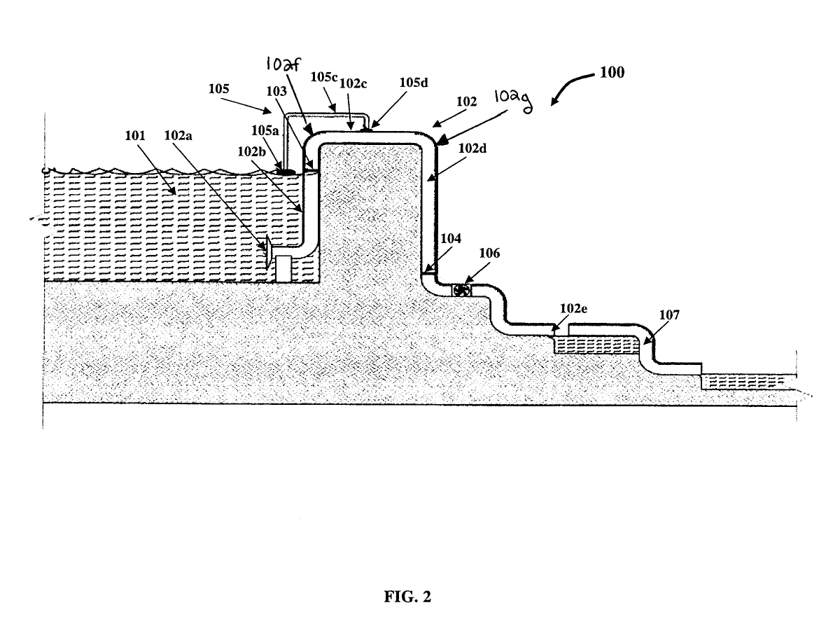

FIG. 2 exemplarily illustrates an apparatus 100 for increasing the energy harnessed from a body of water flowing through a conduit 102 utilizing a pump 105a and a fill tube 105c to establish constant flow. In this embodiment, the pump 105a is disposed in the body of water. In this example, the valves 103 and 104 are initially closed. The valves 103 and 104 are both under water level. Water is already present in the conduit 102 before the valves 103 and 104 are closed. The posterior control valve 104 is at a lower position than the anterior control valve 103.

The pump 105a is engaged to pump the water through the fill tube 105c. The water enters the conduit 102 through the access door 105d. The access door 105d is closed when the conduit 102 is replenished. A constant flow of water is established through the conduit 102 by opening the anterior control valve 103 and the posterior control valve 104. The valves 103 and 104 are then opened simultaneously or one after the other. The anterior control valve 103 is opened before the posterior control valve 104. Water then starts flowing out the outlet 102e. If the descending section 102d of the conduit 102 is much longer than the ascending section 102b, only one valve 103 or 104 is used. The flow can be started by filling the descending section 102d with water.

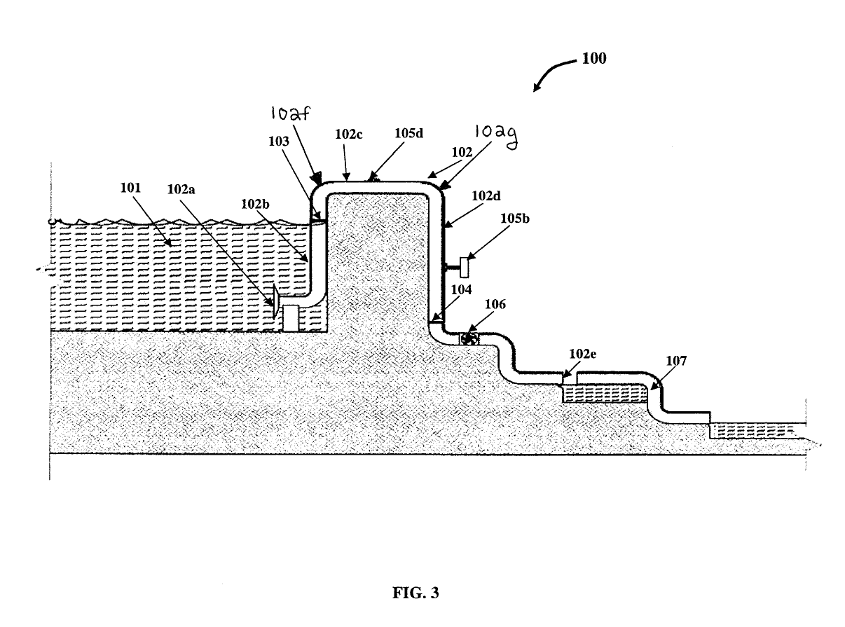

FIG. 3 exemplarily illustrates an apparatus 100 for increasing the energy harnessed from a body of water flowing through a conduit 102 utilizing a siphon 105b to establish constant flow. The siphon 105b is disposed between the anterior control valve 103 and the posterior control valve 104. The anterior control valve 103 and the posterior control valve 104 are initially closed. The siphon 105b is engaged to evacuate air in the portion of the conduit 102 between the anterior control valve 103 and the posterior control valve 104. The air may be evacuated from the top of the conduit 102 or any other opening in the conduit 102. The opening used for siphoning is then sealed.

The anterior control valve 103 is then opened, allowing a constant flow of water into the ascending section 102b of the conduit 102. Subsequently, the posterior control valve 104 is opened, thereby permitting a constant flow of water through the descending section 102d of the conduit 102. The water then flows out through the outlet 102e. The water never fills the siphon 105b under normal operation. In this case, the anterior control valve 103 is provided above the surface of the body of water. The posterior control valve 104 is provided below the level of the anterior control valve 103 to start the flow.

Disclosed herein is a method of increasing a harnessed energy from flow of a liquid body 101 through a conduit 102 using atmospheric pressure exerted on a surface of the liquid body 101. The conduit 102 is provided. The conduit 102 comprises an ascending section 102b and a descending section 102d connected via a connecting section 102c as explained in the detailed description of FIG. 1.

Multiple valves 103 and 104 are provided inside the conduit 102 for regulating the flow of the liquid body 101 through the conduit 102. The liquid body 101 is replenished in the conduit 102. A constant flow of the liquid body 101 is impelled into the conduit 102. The constant flow is impelled by selectively controlling one or more of the valves 103 and 104 and utilizing the atmospheric pressure exerted on the surface of the liquid body 101. The impelled constant flow of the liquid body 101 in the conduit 102 is increased by passing the liquid body 101 through a removably attached extension 107.

The removably attached extension 107 increases the hydraulic head of the liquid body 101. Energy is harnessed from the liquid body 101 flowing with the increased constant flow in the conduit 102 using mechanical force exerted by the impelled constant flow of the liquid body 101.

The foregoing examples have been provided merely for the purpose of explanation and are in no way to be construed as limiting of the present invention. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

1. An apparatus for increasing harnessed energy from a liquid body flowing through a conduit using atmospheric pressure exerted on a surface of said liquid body, comprising:
said conduit having an ascending section and a descending section connected via a connecting section;
said ascending section extending from an inlet below said surface of said liquid body to a first end of said connecting section at a height above the surface of the liquid body;
said descending section extending from an opposite second end of the connecting section at said height above the surface of the liquid body to a predetermined point below the surface of the liquid body;
a plurality of valves disposed inside the conduit for regulating a flow of the liquid body through the conduit;
a fill unit comprising at least one of a pump and a siphon for replenishing the liquid body in the conduit and initiating a constant flow of the liquid body through the conduit;
said constant flow being controlled by selectively modulating at least one of said valves and utilizing said atmospheric pressure exerted on the surface of the liquid body;
at least one turbine located on the descending section of the conduit preferably at a level lower than the surface of the liquid body;
said at least one turbine harnessing the energy from the liquid body flowing with said increased constant flow in the conduit; and
whereby, said harnessed energy is increased by utilizing the atmospheric pressure exerted on the surface of the liquid body resulting in increased constant flow of the liquid body through the conduit.

2. The apparatus for increasing harnessed energy from a liquid body flowing through a conduit using atmospheric pressure exerted on a surface of said liquid body, as described in claim 1, further comprising:
an extension, said extension being removably attached to an outlet disposed at a distal end of said descending section of said conduit, said extension increasing hydraulic head of the liquid body; and
said increase in said hydraulic head increasing said constant flow of the liquid body through the conduit.

3. The apparatus for increasing harnessed energy from a liquid body flowing through a conduit using atmospheric pressure exerted on a surface of said liquid body, as described in claim 2, further comprising at least one additional turbine disposed in said removably attached extension.

4. A method for increasing harnessed energy from a liquid body flowing through a conduit using atmospheric pressure exerted on a surface of said liquid body, comprising the steps of:
providing said conduit having an ascending section and a descending section connected via a connecting section;
said ascending section extending from an inlet below said surface of said liquid body to a first end of said connecting section at a height above the surface of the liquid body;
said descending section extending from an opposite second end of the connecting section at said height above the surface of the liquid body to a predetermined point below the surface of the liquid body;
providing a plurality of valves disposed inside the conduit for regulating a flow of the liquid body through the conduit;
providing a fill unit comprising at least one of a pump and a siphon for replenishing the liquid body in the conduit and initiating a constant flow of the liquid body through the conduit;
said constant flow being controlled by selectively modulating at least one of said valves and utilizing said atmospheric pressure exerted on the surface of the liquid body;
providing at least one turbine located on the descending section of the conduit preferably at a level lower than the surface of the liquid body;
said at least one turbine harnessing the energy from the liquid body flowing with said increased constant flow in the conduit; and
whereby, said harnessed energy is increased by utilizing the atmospheric pressure exerted on the surface of the liquid body resulting in increased constant flow of the liquid body through the conduit.

5. The method for increasing harnessed energy from a liquid body flowing through a conduit using atmospheric pressure exerted on a surface of said liquid body, as described in claim 3, further comprising the steps of:
providing an extension, said extension being removably attached to an outlet disposed at a distal end of said descending section of said conduit, said extension increasing hydraulic head of the liquid body; and
said increase in said hydraulic head increasing said constant flow of the liquid body through the conduit.

6. The method for increasing harnessed energy from a liquid body flowing through a conduit using atmospheric pressure exerted on a surface of said liquid body, as described in claim 5, further comprising the step of providing at least one additional turbine in said removably attached extension.
